(19) United States
(12) Patent Application Publication
(10) Pub. No.: US 2005/0142045 A1
(43) Pub. Date: Jun. 30, 2005

(54) Vehicular Photoelectron air purifier

(76) Inventor: Se Kit Yuen, Hong Kong (CN)

Correspondence Address: Dr. Arthur King Ma, 1030 Coronado Drive, Arcadia, CA, 91007, US

(21) Appl. No.: 10/792,075

(22) Filed: Mar. 2, 2004

Related U.S. Application Data
(63) Continuation-in-part of application No. 10/751,130, filed on Dec. 31, 2003.

(51) Int. Cl. B01J 19/08

(52) U.S. Cl. 422/186.3

(57) ABSTRACT

This invention relates to a vehicular photoelectron air purifier, and its body is a square-columnar structure comprises extractor fan, transformer, circuit board, and polarization end ultraviolet ray radiation tube. Said body is equipped with an assembly of an assembly of replaceable ultraviolet ray radiation tubes comprises of a confluence compartment wherein a carbon fiber strips is affixed thereby provide a mean of eliminating virus; a guarding wall which is having indicial size and sharp of a pre-determined size and sharp of air confluence wall; a metal spring conductor and metal conductor are affixing onto a plurality of conductor compartment therein an polarization end ultraviolet ray tube integrally affixed in the front portion of guarding wall thereby providing a mean of moving in and out chamber of said assembly which contributes a mean for consumer to replace used and dirty ultraviolet ray tube by taking out or moving is of said assembly as needed.

The present invention is a continuation-in-part application of a non-provisional application Ser. No. 10/751130, filed on Dec. 31, 2003.

### BACKGROUND OF THE PRESENT INVENTION

1. Field of the Present Invention

The present invention relates to a vehicular photoelectron air purifier, and more particularly, it relates to an air purifier with a replaceable UVC emitting light, which can eliminate virus, bacillus and mildew and etc. in the air through purifying the air by a polarization end ultraviolet ray, with a vehicular power supply besides the municipal power supply.

2. Description of Related Arts

Insufficient ventilation of indoor or an enclosed room readily makes the air dreggy and leads to the virus and bacillus propagated and spread. In a public and an air conditioning room, therefore, it is necessary to manually purify the air and eliminate virus and bacillus without delay for keeping fresh air in a given room or an area. In an air conditioning room during summer period, purification of indoor air is also a very important problem that is difficult to deal with. More and more attentions are drawn to indoor air purification due to wide diffusion of SARS virus. In a conventional method, an ultraviolet light for eliminating bacillus may cause injure by irradiating human body. In addition, the present conventional ventilating and air conditioning equipment have no air purifying function, which generally are equipped with simple deducting and filtering devices, and it is not cost effective to replace one during mass production. In addition, insufficient ventilation of car, train, airplane, and ship department will also cause the same concerns as described and conventional methods are not sufficient to provide solution. Moreover, none of the present conventional air purifier provides any mean of replaceable UVC emitting device for consumer to replace any malfunction UVC emitting light.

### SUMMARY OF THE PRESENT INVENTION

A main object of the present invention is to provide an air purifier with a replaceable UVC emitting light to overcome the defects in the prior art, and to provide vehicular photoelectron air purifier for purifying the air with high efficiency through the ultraviolet and through such way as combing the ultraviolet and the negative ion by a power supply powered of transportation vehicles such as cars and ships.

Accordingly, a vehicular photoelectron air purifier is disclosed; a main body is a square-columnar structure comprises a plurality of extractor fan, a plurality of transformer, a plurality of circuit board, and a plurality of polarization end, a plurality of ultraviolet ray radiation tube (an UVC emitting device), a plurality of an assembly of an assembly of replaceable ultraviolet ray radiation tubes. Said body is equipped with one air inlet and one air outlet; said air outlet locates at front portion of said body and an air exhaust frame trellis device is provided on a plane of a front end surface of said body; said air inlet locates at a rear portion of said body and said air intake frame trellis device is provided at said rear end of said body; said intake frame trellis device provides an air inlet and is used as a fixed dustproof frame, dustproof net and dustproof cover; said extractor fan is kept close to an inner surface of said air exhaust frame trellis device; there is an air collector between said air inlet and said extractor fan; said polarization end ultraviolet ray radiation tube lies in a center portion of said air collector.

According to another aspect of the present invention, a vehicular photoelectron air purifier is provided, a main body of which is a square-columnar structure comprising a plurality of extractor fan, a plurality of transformer, a plurality of circuit board, a plurality of polarization end ultraviolet ray radiation tube, (an UVC emitting device), a plurality of an assembly of an assembly of replaceable ultraviolet ray radiation tubes and a plurality of cathodal high-voltage discharging carbonized fiber wire. Said body is equipped with one air inlet and one air outlet: An air exhaust frame trellis device with cambered surface structure is provided on a rear upper portion of said body; said outer frame trellis device is provided at a front portion of the body; said air intake frame trellis device is provided at a rear portion of said outer frame trellis device; said intake frame trellis device provides an air inlet and is used as a fixed dustproof frame, dustproof net and dustproof cover; said cathodal high-voltage discharging carbonized fiber wire is fixed in a center portion of a front surface of said an air exhaust frame trellis device; said polarization end ultraviolet ray radiation tube is mounted at said air outlet in said body and lies in said air collector; an extractor fan and an electric motor are kept close to an inner surface of said air intake frame trellis device.

Since ultraviolet has outstanding effect for eliminating virus, bacillus and mildew, the air, under actions of said extractor fan, is forced to pass through around said ultraviolet light tube for the purpose of eliminating virus, bacillus and mildew; because there are two extractor fans arranged abreast along a linear direction of said polarization end ultraviolet ray tube, the air flow increases in amount and treating capacity strengthens so as to sufficiently eliminate virus, bacillus and mildew in the air.

The present invention, employs said polarization end ultraviolet ray to eliminate virus, bacillus and mildew in air; meanwhile, said cathodal high-voltage discharging carbonized fiber wire can increase negative ions in the environment; when the air is drawn into said purifier by said fan, two continuously alternating working modes are available, i.e.; both said ultraviolet radiation and said high voltage ionization negative ion are automatically and alternatively operated so as to provide ideal air purifying effect. A sheltering wall and said air collector are provided around said polarization end ultraviolet ray radiation tube in said main body of the present invention, therefore, said ultraviolet ray shall not irradiate to outside of said main body and thus preventing eye injure of users from leakage of ultraviolet; said purifier of the present invention can use both the municipal power supply and any power supply of transportation vehicles, so it is convenient for carrying and using and applicable for various places.

The present invention employs said assembly of an assembly of replaceable ultraviolet ray radiation tubes to provide a mean of replacing used and dirty ultraviolet ray radiation tube for consumers without the hassle of open up said air purifier when replacing said used and dirty ultraviolet ray radiation tube

### BRIEF DESCRIPTION OF THE DRAWINGS

FIG. 1 is a side section view of the present invention which shows the UVC emitting device.

FIG. 2 is a top section view of the present invention.

FIG. 3 is a side view of the present invention.

FIG. 4 is other side section view of the present invention

FIG. 5 is a rear section view of the present invention.

FIG. 6 is front view of the present invention.

FIG. 7 is an underneath view of the present invention.

FIG. 8 is another side view of the present invention.

FIG. 9 is a top view of the prevent invention.

FIG. 10 is an underneath view of the present invention.

FIG. 11 is a composite view of the present invention.

FIG. 12 is filter composite view of the present invention.

FIG. 13 is assembly of replaceable ultraviolet ray radiation tubes composite view of the present invention.

FIG. 14 is a detail section view of the present invention.

### DETAILED DESCRIPTION OF THE PREFERRED EMBODIMENT

A preferred embodiment of the present invention is a vehicular photoelectron air purifier, which mainly comprises a plurality rows of extractor fans, a plurality of polarization end ultraviolet ray radiation tubes, an assembly of replaceable ultraviolet ray radiation tubes and a plurality of air collecting walls. When air is drawn by said extractor fan into said vehicular photoelectron air purifier, it will ignite said polarization end ultraviolet ray radiation tube to radiate a polarization end ultraviolet ray which can eliminate virus, bacillus and mildew in the air that flows through said tube. Said vehicular photoelectron air purifier is equipped with one air inlet and one air outlet. Said polarization end ultraviolet ray radiation tube is mounted at said air inlet inside of said main body, while said extractor fan is fixed at said air outlet. When air containing virus, bacillus and mildew is drawn in the body through said air outlet, flowing air can easily enter and traverse through said air outlet, said flowing air can easily enter and traverse through said air intake frame trellis device of said vehicular photoelectron air purifier and then reach said air exhaust frame trellis device so that the air containing virus, bacillus and mildew must contact with said polarization end ultraviolet ray radiation tube and thus said polarization end ultraviolet ray eliminates virus, bacillus and mildew contained in the air.

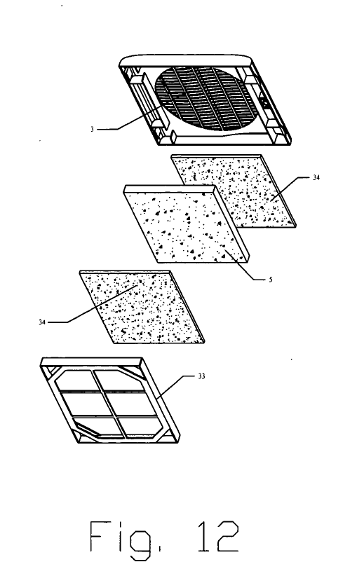

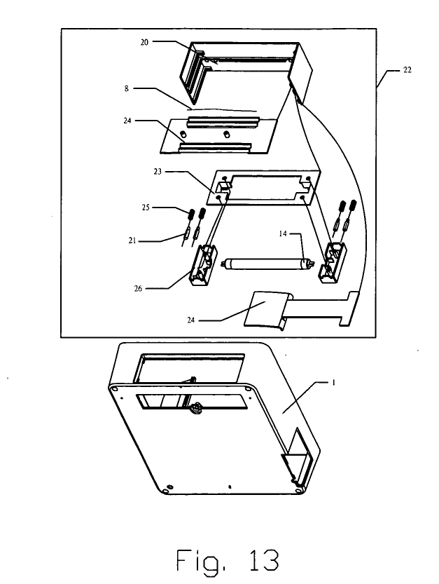

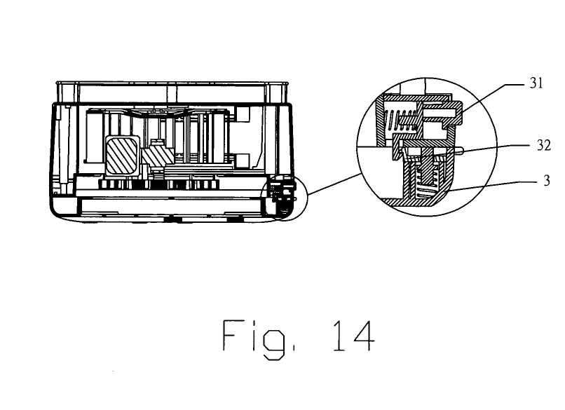

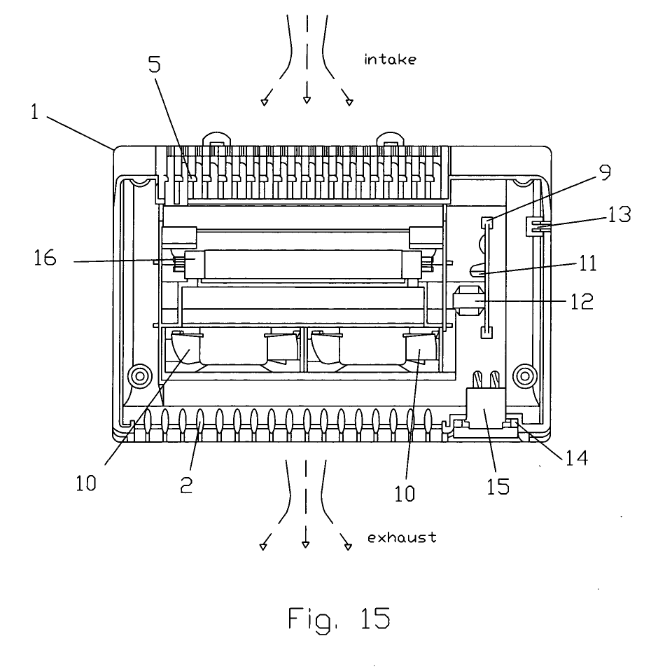

Referring to FIG. 11, FIG. 12 and FIC 15, it further discloses the composition of said preferred embodiment of said invention. Said vehicular photoelectron air purifier has a main body 1 with square-columnar structure, and an air exhaust frame ventilation grill device 2 is provided on a plane of a front portion of said body 1; air with the bacillus eliminated is exhausted through said air exhaust frame trellis device 2. An activated carbon fiber filter 5 is provided at a front portion of said body 1, which provides an air inlet and is used as a fixed ventilation turbine 6, electronic motor 7 and carbon fiber stripe 8; function indicating light 10 is kept close to the inner surface of said air exhaust frame ventilation grill device 2. An assembly of an assembly of replaceable ultraviolet ray radiation tubes 22 comprises of a confluence compartment 20 wherein a carbon fiber strips 6 is affixed thereby provide a mean of eliminating virus; a guarding wall which is having indicial size and sharp of a pre-determined size and sharp of air confluence wall 24; a metal spring conductor 25 and metal conductors 21 are affixing onto a plurality of conductor compartments 26 therein an polarization end ultraviolet ray tube 14 integrally affixed in the front portion of said guarding wall 24. Said assembly 22 of replaceable ultraviolet ray radiation tubes is having a pre-determined size and sharp which is identical to a pre-determined size and sharp of a rectangular hold of main body 1 whereby said assembly 22 can affix onto thru said rectangular hold of main body 1 providing a mean of moving in and out chamber of said assembly which contributes a mean for consumer to replace used and dirty ultraviolet ray tube by taking out or moving is of said assembly.

A power switch 11 is available on an upper part of a electronics circuit board 9 which is for protecting and fixing electronic generator of power supply; A hole 39 is provided at a rear portion of said body 1 and is used for fixing assembly of replaceable ultraviolet ray radiation tubes 22 that is for consumer to replace used or dirty a polarization end ultraviolet ray radiation tube 16. There is a hole 15 above a led indicator 16, which is used for fixing LBDs 10 that is provided for indicating functions.

In practice, when said vehicular photoelectron air purifier is operated, air containing virus, bacillus and mildew is drawn by said ventilation turbine 6 into said air collecting wall in said main body 1 through said inward fan grill 4, so flowing air can easily enter said air collecting wall and then reaches said air exhaust frame ventilation grill device 2. Said polarization end ultraviolet ray radiation tube 14 is provided in a center portion of said air collecting wall, this means that when air containing virus, bacillus and mildew flows and enters said air collectors 18 and 19, and then enter into a confluence compartment 20 between said polarization end ultraviolet ray radiation tube 14 and said air collecting wall 19, said polarization end ultraviolet ray radiation tube 14 will radiate polarization end ultraviolet ray so as to eliminate virus, bacillus and mildew contained in the air; then purified clean and fresh air is, by said extractor fan 10, exhausted out of the air exhaust frame trellis device 2.

A sheltering walls 21 are provided at a front portion and a rear portion of said air collecting wall 18 for prohibiting user's eyes from injure by said polarization end ultraviolet ray radiating to the outside of said body 1.

An input power of the present invention is, through said switch 15 and through a full wave band rectifying circuit, supplied to the extractor fan via the speed control circuit, and operate a full wave rectifying circuit of said polarization end ultraviolet ray radiation tube 15 via a DC-AC converting circuit. This structure details of an electronic circuits in said vehicular photoelectron air purifier belongs to the prior art, therefore it is omitted here.

Said vehicular photoelectron air purifier of this invention is light and convenient for user's carrying (a train or car plug is necessary) so that user can breathe in clean and fresh air free from virus, bacillus and mildew in various places, and thus the respiratory infectious disease can be effectively prevented.

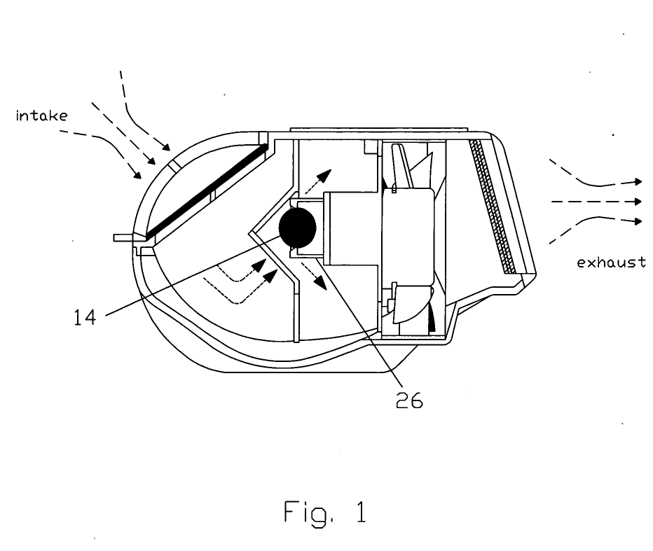

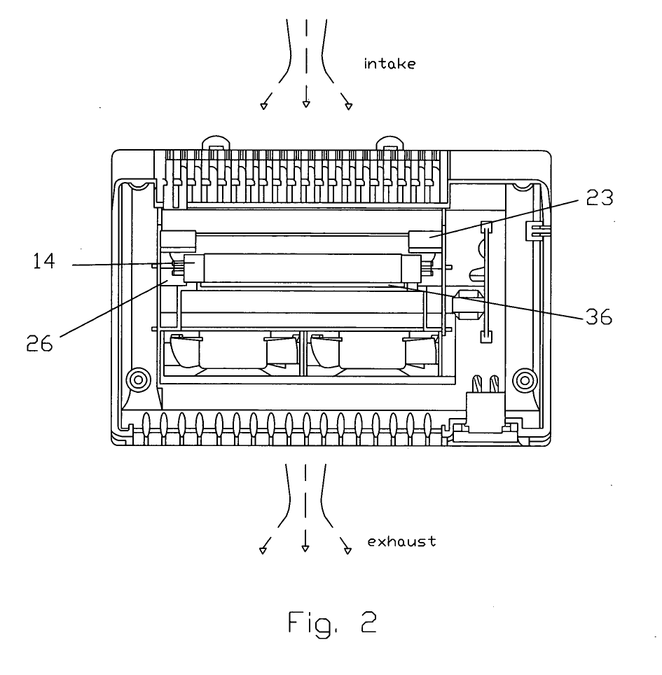

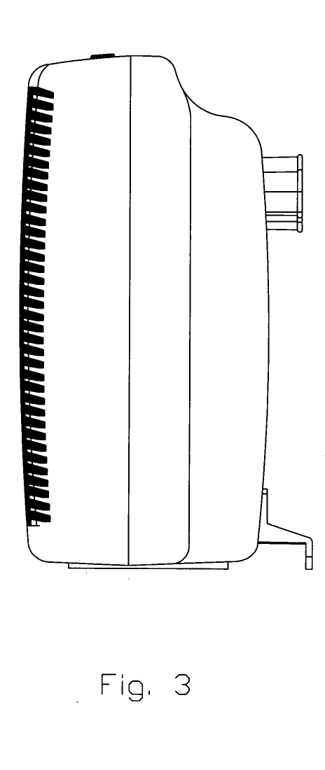

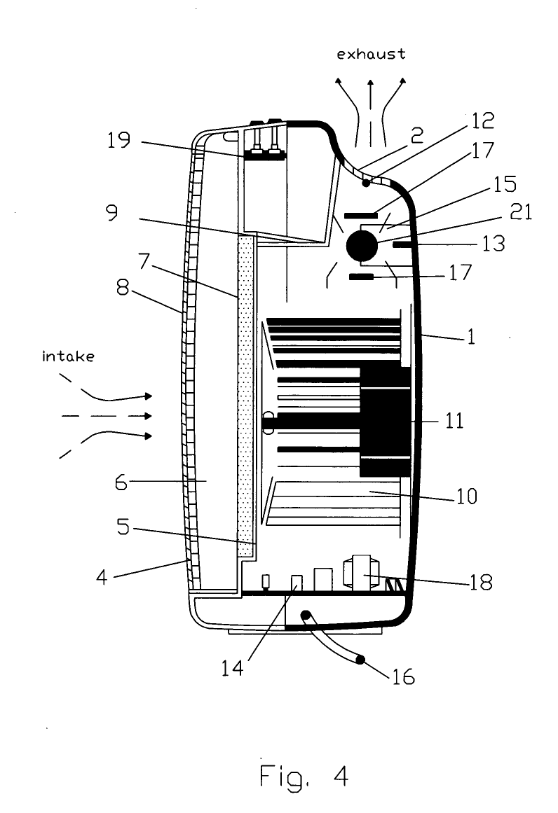

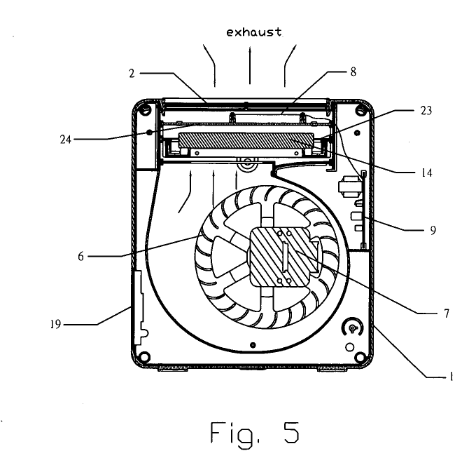

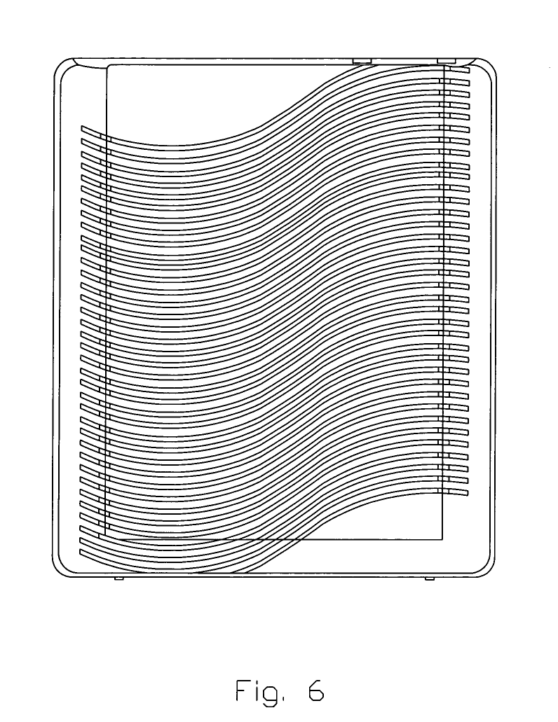

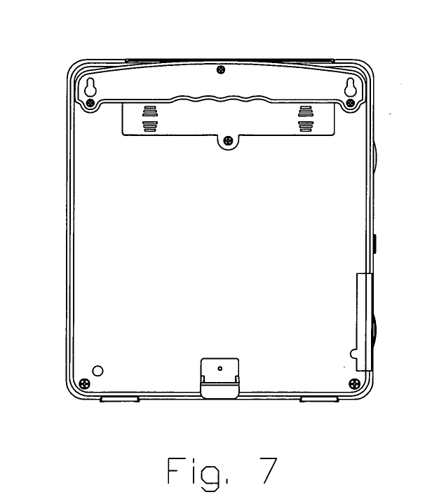

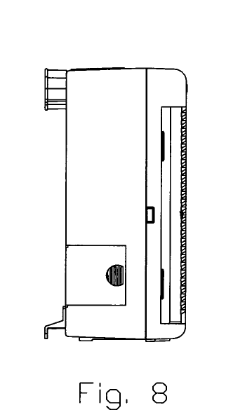

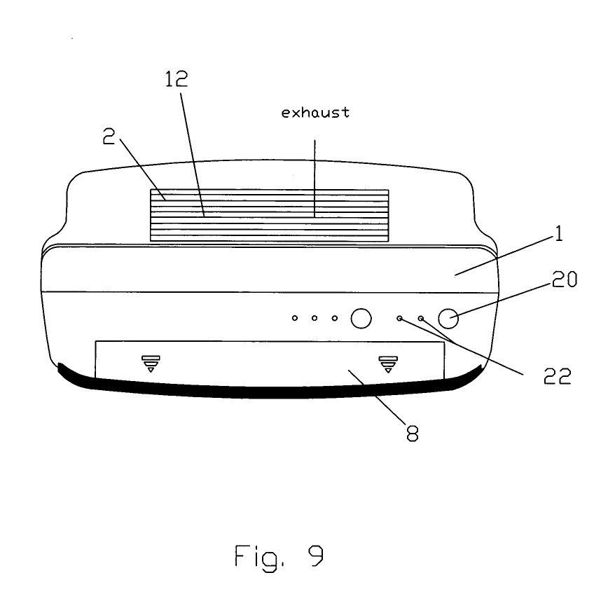

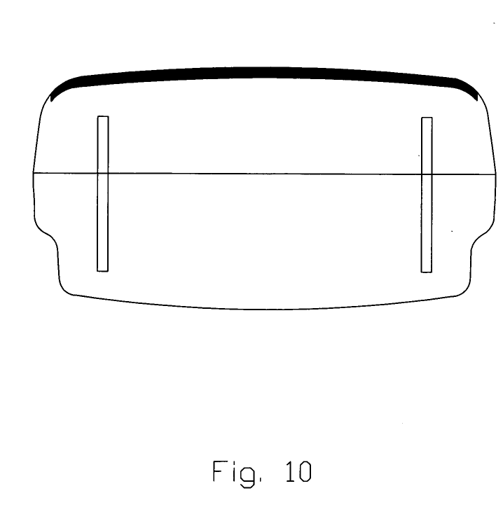

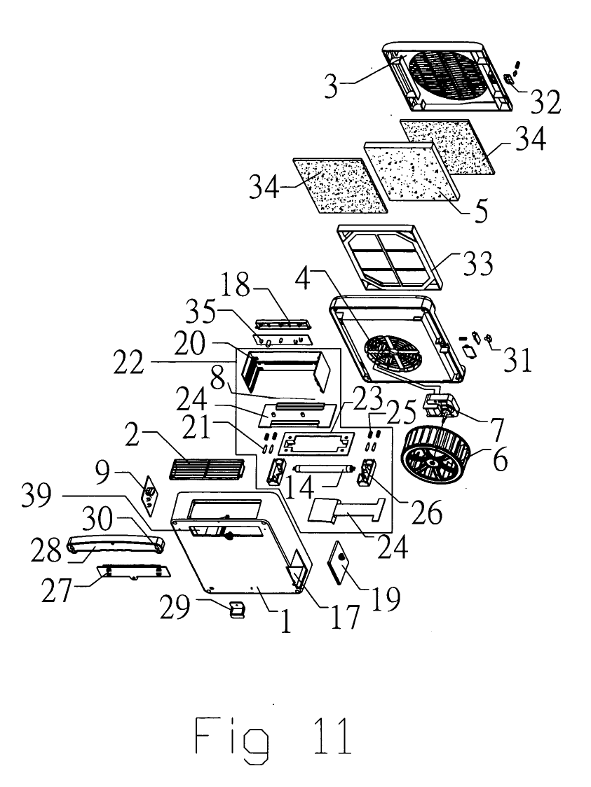

FIG. 1 and FIG. 2 show a detailed structure of said an assembly of replaceable ultraviolet ray radiation tubes for said photoelectron air purifier. Referring to FIG. 15, said vehicular photoelectron air purifier has a main body 1 with square-columnar structure, and an air exhaust frame trellis device 2 is provided on a plane of a front portion of said body 1; air with the bacillus eliminated is exhausted through said air exhaust frame trellis device 2. A air intake frame trellis device 5 is provided at a rear portion of said body 1, which provides an air inlet and is used as a fixed dustproof frame 6, dustproof net 7 and dustproof cover 8; an extractor fan 10 is kept close to the inner surface of said air exhaust frame trellis device 2.

An electronic converter 11 is available on an upper part of a support frame 9 which is for protecting and fixing electronic generator of power supply; a power supply socket 13 is provided on side of said body 1 and provides a connection to a vehicular power supply or the municipal power supply to the user.

A quadrate hole 14 is provided at a front portion of said body 1 and is used for fixing a switch 15 that is for controlling functions of an extractor fan 10 and a polarization end ultraviolet ray radiation tube 16. There is a hole 16 above said switch 15, which is used for fixing LBDs 17 that is provided for indicating functions.

In practice, when said vehicular photoelectron air purifier is operated, air containing virus, bacillus and mildew is drawn by said extractor fan 10 into said air collecting wall 18 in said main body 1 through said dustproof net 7, so flowing air can easily enter said air collecting wall 18 and then reaches said air exhaust frame trellis device 2. Said polarization end ultraviolet ray radiation tube 16 is provided in a center portion of said air collecting wall 18; this means that when air containing virus, bacillus and mildew flows and enters said air collectors 18 and 19, and then enter into said air inlet 20 between said polarization end ultraviolet ray radiation tube 16 and said air collecting wall 19, said polarization end ultraviolet ray radiation tube 16 will radiate polarization end ultraviolet ray so as to eliminate virus, bacillus and mildew contained in the air; then purified clean and fresh air is, by said extractor fan 10, exhausted out of the air exhaust frame trellis device 2.

A sheltering walls 21 are provided at a front portion and a rear portion of said air collecting wall 18 for prohibiting user's eyes from injure by said polarization end ultraviolet ray radiating to the outside of said body 1.

An input power of the present invention is, through said switch 15 and through a full wave band rectifying circuit, supplied to the extractor fan via the speed control circuit, and operate a full wave rectifying circuit of said polarization end ultraviolet ray radiation tube 15 via a DC-AC converting circuit. This structure details of an electronic circuits in said vehicular photoelectron air purifier belongs to the prior art, therefore it is omitted here.

1. A vehicular photoelectron air purifier comprising:
a three-dimensional, square-columnar structure housing for actuating an assemblage having a plurality of air inlets and a plurality of air outlets with predetermined sharp, wherein the three-dimensional housing comprises:
at least two extractor fan mean horizontally inserted and engaged in said three-dimensional housing for mean of drawing air into said three-dimensional housing through said air inlet, through a ultraviolet radiation tube mean and out of said housing through said air outlet,
an air aggregator integrally provided between said extractor fan mean and said housing,
an ultraviolet radiation tube mean for generating ultraviolet rays to produce and increase the quantity of anions is integrally connected within said housing, said air inlet and air outlet are connected at both ends of said a ultraviolet radiation tube mean,
an electric circuit with a voltage transformer connected with an indicator light, a starter electrically connected via said electric circuit to said ultraviolet radiation tube,
a switch on said housing electrically connected via said electric circuit between said housing and said air drawing means, and a plug on an electric cord electrically connected to said electric circuit to engage with a wall socket to receive electricity therefrom;
a high negative voltage discharge/carbonated fiber is connected between said ultraviolet radiation tube and said air outlet.
an anion generating circuit and an ultraviolet radiation tube generating 253.7 nm start up circuit.
an air intake frame trellis device is provided at a rear portion of said body; an intake frame trellis device provides said air inlet and is used as a fixed dustproof frame, dustproof net;
a dustproof cover; said extractor fan is kept close to an inner surface of said air exhaust frame trellis device; there is an air collector between said air inlet and said extractor fan; said polarization end ultraviolet ray radiation tube lies in a center portion of said air collector;
an assembly of an assembly of replaceable ultraviolet ray radiation tubes comprises of a confluence compartment wherein a carbon fiber strips is affixed thereby provide a mean of eliminating virus; a guarding wall which is having indicial size and sharp of a pre-determined size and sharp of air confluence wall; a metal spring conductor and metal conductor are affixing onto a plurality of conductor compartment therein an polarization end ultraviolet ray tube integrally affixed in the front portion of guarding wall.

2. As recited in claim 1, said an assembly of an assembly of replaceable ultraviolet ray radiation tubes is having a pre-determined size and sharp which is identical to a pre-determined size and sharp of a rectangular hold of main body whereby providing a mean of moving in and out chamber of said assembly which contributes a mean for consumer to replace used and dirty ultraviolet ray tube by taking out or moving is of said assembly.

3. As recited in claim 1, said vehicular photoelectron air purifier comprises at least two extractor fan arranged in said square-columnar body abreast along the linear direction of the polarization end ultraviolet ray radiation tube, wherein said air collector is composed of a space surrounded by an air collecting wall and a sheltering wall, and said polarization end ultraviolet ray radiation tube is fixed between a front and a rear portion of sheltering walls so that there is no light ray is radiated out of the purifier.

4. As recited in claim 1, said vehicular photoelectron air purifier, wherein a support frame is mounted on the side inside said body, an electronic converter and an electronic generator of power supply are provided at an upper end thereof; a power socket for connecting to a vehicular power supply or the municipal power is provided on side surface of said body.

5. As recited in claim 1, said vehicular photoelectron air purifier, wherein there is a quadrate hole on a front end surface of said body, in which a power supply switch for controlling said extractor fan and said polarization end ultraviolet ray radiation tube is arranged; there is a hole above said quadrate hole, in which, a LBDs for indicating functions is provided.

6. As recited in claim 1, said vehicular photoelectron air purifier, wherein, said body is in square-columnar structure comprising at least one extractor fan, transformer, at least one circuit board, at least a polarization end ultraviolet ray radiation tube, and a least one cathodal high-voltage discharging carbonized fiber wire. Said body is equipped with one air inlet and one air outlet; the air exhaust frame trellis device with cambered surface structure is provided on a rear upper portion of said body; an outer frame trellis device is provided at a front portion of said body; an air intake frame trellis device is provided at a rear portion of said outer frame trellis device; said intake frame trellis device provides an air inlet and is used as a fixed dustproof frame, dustproof net and dustproof cover; said cathodal high-voltage discharging carbonized fiber wire is fixed in a center portion of front surface of said air exhaust frame trellis device; said polarization end ultraviolet ray radiation tube is mounted at said air outlet in said body and lies in said air collector; said extractor fan and an electric motor are kept close to the inner surface of the air intake frame trellis device.

7. As recited in claim 1, said vehicular photoelectron air purifier, wherein said air collector is composed of a space surrounded by an air collecting wall and a sheltering wall, and said polarization end ultraviolet ray radiation tube is fixed between a front and a rear portion of said sheltering walls so that there is no light ray is radiated out of the purifier.

8. As recited in claim 5, said vehicular photoelectron air purifier, wherein said air collector is composed of a space surrounded by an air collecting wall and a sheltering wall, and said polarization end ultraviolet ray radiation tube is fixed between a front and a rear portion of said sheltering walls so that there is no light ray is radiated out of the purifier.

9. As recited in claim 1, said vehicular photoelectron air purifier, wherein there is an electronic converter, an electronic generator of power supply, and the power line are provided. At a lower portion in said body; a power socket for connecting to the vehicular power supply or the municipal power is provided on the side surface of the body.

10. As recited in claim 5, said vehicular photoelectron air purifier, wherein there is an electronic converter, an electronic generator of power supply, and the power line are provided. At a lower portion in said body; a power socket for connecting to the vehicular power supply or the municipal power is provided on the side surface of the body.

11. As recited in claim 1, said vehicular photoelectron air purifier, wherein there is a quadrate hole on the upper surface of said body, in which a power supply switch for controlling said electric motor, said extractor fan, said polarization end ultraviolet ray radiation tube and said carbonized fiber wire is mounted. There are two holes above said quadrate hole, by which two LBDs with different colors are fixed.

12. A vehicular photoelectron air purifier, the body of which is in square-columnar structure, in which comprising: extractor fan, transformer, circuit board, and polarization end ultraviolet ray radiation tube, it is characterized that the said body is equipped with one air inlet and one air outlet; the air outlet locates at the front of the body and an air exhaust frame trellis device is provided on the plane of the front end surface of the body; the air inlet locates at the front of the body and an air exhaust frame trellis device is provided on the plane of the front end surface of the body; the air inlet locates at the rear of the body and an air intake frame trellis device is provided at the rear end of the body; the intake frame trellis device provides an air inlet and is used as a fixed dustproof frame, dustproof net and dustproof cover; the extractor fan is kept close to the inner surface of the air exhaust frame trellis device; there is an air collector between the air inlet and the extractor fan; the polarization end ultraviolet ray radiation tube lies in the center of the air collector.
